(19) United States
(12) Patent Application Publication
(10) Pub. No.: US 2022/0274210 A1
(43) Pub. Date: Sep. 1, 2022

(54) METHODS FOR LASER PROCESSING TRANSPARENT MATERIAL USING PULSED LASER BEAM FOCAL LINES

(71) Applicant: CORNING INCORPORATED, Corning, NY (US)

(72) Inventors: Alejandro Antonio Becker, Stockdorf (DE); Tobias Christian Roeder, Munich (DE)

(21) Appl. No.: 17/677,371

(22) Filed: Feb. 22, 2022

Related U.S. Application Data
(60) Provisional application No. 63/154,173, filed on Feb. 26, 2021.

(51) Int. Cl. B23K 26/53; B23K 26/0622; B23K 26/06; B23K 26/073

(52) U.S. Cl. CPC B23K 26/53; B23K 26/0624; B23K 26/0648; B23K 26/0738; B23K 26/0613; B23K 2103/54

(57) ABSTRACT

A method for processing a transparent workpiece includes forming a first contour line, comprising a first plurality of defects, in the transparent workpiece; forming a second contour line, comprising a second plurality of defects, in the transparent workpiece, wherein the second contour line defines a second contour intersecting the first contour line at an intersection point, wherein the laser pulse energy of the second pulsed laser beam is increased from a first laser pulse energy to a second laser pulse energy at a first distance from the intersection point; and wherein the laser pulse energy of the second pulsed laser beam is decreasing from the second laser pulse energy to the first laser pulse energy at a second distance from the intersection point.

### CROSS-REFERENCE TO RELATED APPLICATIONS

This application claims the benefit of priority under 35 U.S.C. § 120 of U.S. Application Ser. No. 63/154,173, filed on Feb. 26, 2021, the content of which is relied upon and incorporated herein by reference in its entirety.

### BACKGROUND

### Field

The present specification generally relates to apparatuses and methods for laser processing transparent workpieces, and more particularly, to cross-cutting perforations in transparent workpieces.

### Technical Background

The area of laser processing of materials encompasses a wide variety of applications that involve cutting, drilling, milling, welding, melting, etc. of different types of materials. Among these processes, one that is of particular interest is cutting or separating transparent substrates in a process that may be utilized in the production of materials such as glass, sapphire, or fused silica for thin film transistors (TFT) or display materials for electronic devices.

From process development and cost perspectives there are many opportunities for improvement in cutting and separating glass substrates. It is of great interest to have a faster, cleaner, cheaper, more repeatable, and more reliable method of separating glass substrates than what is currently practiced in the market. Accordingly, a need exists for alternative improved methods for separating glass substrates.

### SUMMARY

A first embodiment of the present disclosure includes a method for processing a transparent workpiece, the method comprising: forming a first contour line in the transparent workpiece, the first contour line comprising a first plurality of defects in the transparent workpiece such that the first contour line defines a first contour, wherein forming the first contour line comprises: directing a first pulsed laser beam oriented along a beam pathway and output by a beam source through an aspheric optical element and into the transparent workpiece such that a portion of the first pulsed laser beam directed into the transparent workpiece generates an induced absorption within the transparent workpiece, the induced absorption creating a defect within the transparent workpiece; and translating the transparent workpiece and the first pulsed laser beam relative to each other along the first contour line, thereby laser forming the first plurality of defects along the first contour line within the transparent workpiece; forming a second contour line in the transparent workpiece, the second contour line comprising a second plurality of defects in the transparent workpiece such that the second contour line defines a second contour intersecting the first contour line at an intersection point, wherein forming the second contour line comprises: directing a second pulsed laser beam oriented along a beam pathway and output by a beam source through an aspheric optical element and into the transparent workpiece such that a portion of the second pulsed laser beam directed into the transparent workpiece generates an induced absorption within the transparent workpiece, the induced absorption producing a modification of the transparent workpiece along the second contour line to create a defect within the transparent workpiece; and translating the transparent workpiece and the second pulsed laser beam relative to each other along the second contour line, thereby laser forming the second plurality of defects along the contour line within the transparent workpiece, wherein the laser pulse energy of the second pulsed laser beam is increased from a first laser pulse energy to a second laser pulse energy at a first distance from the intersection point where an optical area of the second pulsed laser beam interacts with an optical area of the first contour line; and wherein the laser pulse energy of the second pulsed laser beam is decreasing from the second laser pulse energy to the first laser pulse energy at a second distance from the intersection point where the optical area of the second pulsed laser beam does not interact with the optical area of the first contour line.

A second embodiment of the present disclosure may include the first embodiment, wherein the portion of the first pulsed laser beam directed into the transparent workpiece comprises: a wavelength λ; a spot size wₒ; and a cross section that comprises a Rayleigh range Z_{R} that is greater than

$${F}_{D} \frac{π {w}_{0 ,}^{2}}{λ} ,$$

where F_{D} is a dimensionless divergence factor comprising a value of 10 or greater.

A third embodiment of the present disclosure may include the first to second embodiment, wherein the portion of the second pulsed laser beam directed into the transparent workpiece comprises: a wavelength λ; a spot size wₒ; and a cross section that comprises a Rayleigh range Z_{R} that is greater than

$${F}_{D} \frac{π {w}_{0 ,}^{2}}{λ} ,$$

where F_{D} is a dimensionless divergence factor comprising a value of 10 or greater.

A fourth embodiment of the present disclosure may include the first to third embodiment, wherein the second laser pulse energy is twice the first laser pulse energy.

A fifth embodiment of the present disclosure may include the first to fourth embodiment, wherein the first distance is about 100 μm to about 500 μm.

A sixth embodiment of the present disclosure may include the first to fourth embodiment, wherein the first distance is about 100 μm to about 300 μm.

A seventh embodiment of the present disclosure may include the first to sixth embodiment, wherein the second distance is about 100 μm to about 500 μm.

A eighth embodiment of the present disclosure may include the first to sixth embodiment, wherein the second distance is about 100 μm to about 300 μm.

A ninth embodiment of the present disclosure may include the first to eighth embodiment, wherein the first pulsed laser beam and second pulsed laser beam has a wavelength λ and wherein the transparent workpiece has combined losses due to linear absorption and scattering less than 20%/mm in the beam propagation direction.

A tenth embodiment of the present disclosure may include the first to ninth embodiment, wherein the first beam source and second beam source comprises respectively a first pulsed beam source and a second pulsed beam source that produces pulse bursts with from about 2 sub-pulses per pulse burst to about 30 sub-pulses per pulse burst and a pulse burst energy is from about 100 μJ to about 600 μJ per pulse burst.

A eleventh embodiment of the present disclosure includes a transparent workpiece, comprising: a first contour line in the transparent workpiece, wherein the first contour line comprises a first plurality of defects in the transparent workpiece; and a second contour line in the transparent workpiece, the second contour line comprising a second plurality of defects in the transparent workpiece such that the second contour line defines a second contour intersecting the first contour line at an intersection point, wherein the second plurality of defects extends at least partially through a thickness of the transparent workpiece from a first distance prior to the intersection point to a second distance after the intersection point.

A twelfth embodiment of the present disclosure may include the eleventh embodiment, wherein the second plurality of defects extends completely through the thickness of the transparent workpiece at the intersection point.

A thirteenth embodiment of the present disclosure may include the eleventh to twelfth embodiment, wherein the first distance is about 100 μm to about 500 μm.

A fourteenth embodiment of the present disclosure may include the eleventh to twelfth embodiment, wherein the first distance is about 100 μm to about 300 μm.

A fifteenth embodiment of the present disclosure may include the eleventh to fourteenth embodiment, wherein the second distance is about 100 μm to about 500 μm.

A sixteenth embodiment of the present disclosure may include a method for processing a transparent workpiece, the method comprising: forming a first contour line in the transparent workpiece, the first contour line comprising a first plurality of defects in the transparent workpiece such that the first contour line defines a first contour, wherein forming the first contour line comprises: directing a first pulsed laser beam oriented along a beam pathway and output by a beam source through an aspheric optical element and into the transparent workpiece such that a portion of the first pulsed laser beam directed into the transparent workpiece generates an induced absorption within the transparent workpiece, the induced absorption producing a modification of the transparent workpiece along the first contour line to create a defect within the transparent workpiece; and translating the transparent workpiece and the first pulsed laser beam relative to each other along the first contour line, thereby laser forming the first plurality of defects along the first contour line within the transparent workpiece; wherein the laser pulse energy of the first pulsed laser beam is increased from the first laser pulse energy to the second laser pulse energy at a first distance to an edge of the transparent material where an optical area of the first pulsed laser beam interacts with an optical area of the edge of the transparent material.

A seventeenth embodiment of the present disclosure may include the sixteenth embodiment, wherein the portion of the first pulsed laser beam directed into the transparent workpiece comprises: a wavelength λ; a spot size wₒ; and a cross section that comprises a Rayleigh range Z_{R} that is greater than

$${F}_{D} \frac{π {w}_{0 ,}^{2}}{λ} ,$$

where F_{D} is a dimensionless divergence factor comprising a value of 10 or greater.

A eighteenth embodiment of the present disclosure may include the sixteenth to seventeenth embodiment, wherein the second laser pulse energy is twice the first laser pulse energy.

A nineteenth embodiment of the present disclosure may include the sixteenth to eighteenth embodiment, wherein the first pulsed laser beam and second pulsed laser beam has a wavelength λ and wherein the transparent workpiece has combined losses due to linear absorption and scattering less than 20%/mm in the beam propagation direction.

A twentieth embodiment of the present disclosure may include the sixteenth to nineteenth embodiment, wherein the first beam source and second beam source comprises respectively a first pulsed beam source and a second pulsed beam source that produces pulse bursts with from about 2 sub-pulses per pulse burst to about 30 sub-pulses per pulse burst and a pulse burst energy is from about 100 μJ to about 600 μJ per pulse burst.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically depicts the formation of a first contour line of defects in a transparent workpiece, according to one or more embodiments described herein;

FIG. 1B schematically depicts an example pulsed laser beam focal line during processing of a transparent workpiece, according to one or more embodiments described herein;

FIG. 2A schematically depicts the formation of a second contour line of defects in a transparent workpiece, according to one or more embodiments described herein;

FIG. 2B depicts a cross section of a transparent workpiece having a first contour line of defects and a second contour line of defects formed therein, according to one or more embodiments described herein

FIG. 3 schematically depicts an optical assembly for pulsed laser processing, according to one or more embodiments described herein;

### DETAILED DESCRIPTION

Reference will now be made in detail to embodiments of processes for laser processing transparent workpieces, such as glass workpieces, examples of which are illustrated in the accompanying drawings. Whenever possible, the same reference numerals will be used throughout the drawings to refer to the same or like parts. According to one or more embodiments described herein, a transparent workpiece may be laser processed to form a contour line in the transparent workpiece comprising a series of defects that define a desired perimeter of one or more apertures through the transparent workpiece. According to one embodiment, a pulsed laser outputs a pulsed laser beam through an aspheric optical element such that the pulsed laser beam projects a pulsed laser beam focal line that is directed into the transparent workpiece. The pulsed laser beam focal line may be utilized to create a series of defects in the transparent workpiece thereby defining the contour line. These defects may be referred to, in various embodiments herein, as line defects, perforations, or nano-perforations in the workpiece. Various embodiments of methods and apparatuses for processing a transparent workpiece will be described herein with specific reference to the appended drawings.

The phrase “transparent workpiece,” as used herein, means a workpiece formed from glass or glass-ceramic which is transparent, where the term “transparent,” as used herein, means that the material has an optical absorption of less than about 20% per mm of material depth, such as less than about 10% per mm of material depth for the specified pulsed laser wavelength, or such as less than about 1% per mm of material depth for the specified pulsed laser wavelength. According to one or more embodiments, the transparent workpiece may have a thickness of from about 50 microns (μm) to about 10 mm, such as from about 100 μm to about 5 mm, from about 0.5 mm to about 3 mm, or from about 100 μm to about 2 mm, for example, 100 μm, 250 μm, 300 μm, 500 μm, 700 μm, 1 mm, 1.2 mm, 1.5 mm, 2 mm, 5 mm, 7 mm, or the like.

According to one or more embodiments, the present disclosure provides methods for processing workpieces. As used herein, “laser processing” may include forming contour lines in transparent workpieces, separating transparent workpieces, or combinations thereof. Transparent workpieces may comprise glass workpieces formed from glass compositions, such as borosilicate glass, soda-lime glass, aluminosilicate glass, alkali aluminosilicate glass, alkaline earth aluminosilicate glass, alkaline earth boro-aluminosilicate glass, fused silica, or crystalline materials such as sapphire, silicon, gallium arsenide, or combinations thereof. In embodiments, the glass may be ion-exchangeable, such that the glass composition can undergo ion-exchange for mechanical strengthening before or after laser processing the transparent workpiece and before or after chemical etching of the transparent workpiece. For example, the transparent workpiece may comprise ion exchanged or ion exchangeable glass, such as Corning Gorilla® Glass available from Corning Incorporated of Corning, N.Y. (e.g., code 2318, code 2319, and code 2320). Further, these ion exchanged glasses may have coefficients of thermal expansion (CTE) of from about 6 ppm/° C. to about 10 ppm/° C. In embodiments, the glass composition of the transparent workpiece may include greater than about 1.0 mol. % boron and/or compounds containing boron, including, without limitation, B₂O₃. In another embodiment, the glass compositions from which the transparent workpieces are formed include less than or equal to about 1.0 mol. % of oxides of boron and/or compounds containing boron. In embodiments, the glass compositions from which the transparent workpieces are formed include greater than or equal to about 92.5 wt % of silica. Moreover, the transparent workpiece may comprise other components which are transparent to the wavelength of the laser, for example, crystals such as sapphire or zinc selenide.

Some transparent workpieces may be utilized as display and/or TFT (thin film transistor) substrates. Some examples of such glasses or glass compositions suitable for display or TFT use are EAGLE XG®, CONTEGO, and CORNING LOTUS™ available from Corning Incorporated of Corning, N.Y. The alkaline earth boro-aluminosilicate glass compositions may be formulated to be suitable for use as substrates for electronic applications including, without limitation, substrates for TFTs. The glass compositions used in conjunction with TFTs typically have CTEs similar to that of silicon (such as less than 5×10⁻⁶/K, or even less than 4×10⁻⁶/K, for example, approximately 3×10⁻⁶/K, or about 2.5×10⁻⁶/K to about 3.5×10⁻⁶/K), and have low levels of alkali within the glass. Low levels of alkali (e.g., trace amounts of about 0 wt. % to 2 wt. %, such as less than 1 wt. %, for example, less than 0.5 wt. %) may be used in TFT applications because alkali dopants, under some conditions, leach out of glass and contaminate or “poison” the TFTs, possibly rendering the TFTs inoperable. According to embodiments, the laser cutting processes described herein may be used to form apertures within transparent workpieces in a controlled fashion with negligible debris, minimum defects, and low subsurface damage to the edges, preserving workpiece integrity and strength.

The phrase “contour line,” as used herein, denotes a line (e.g., a line, a curve, etc.) formed along a contour that extends along the surface of a transparent workpiece. The contour line generally consists of one or more defects introduced into the transparent workpiece using various techniques. As used herein, a “defect” may include an area of modified material (relative to the bulk material), void space, scratch, flaw, hole, or other deformities in the transparent workpiece which enables separation of material of the transparent workpiece along the contour line by application of a chemical etching solution to the transparent workpiece. While not intending to be limited by theory, the chemical etching solution may remove material of the transparent workpiece at and immediately surrounding each defect, thereby enlarging each defect such that voids formed from adjacent defects overlap, ultimately leading to separation of the transparent workpiece along the contour line.

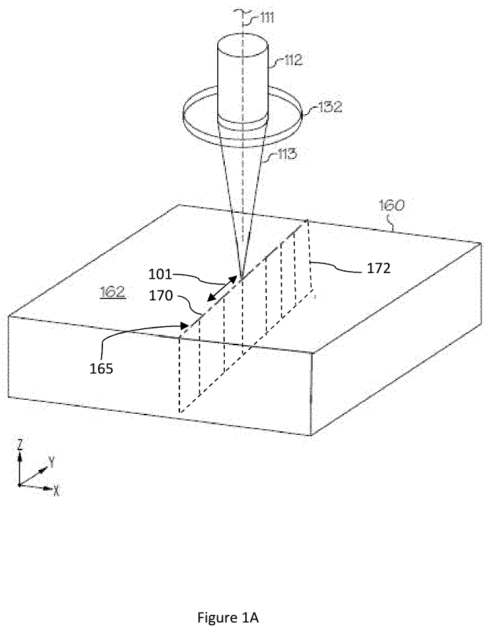

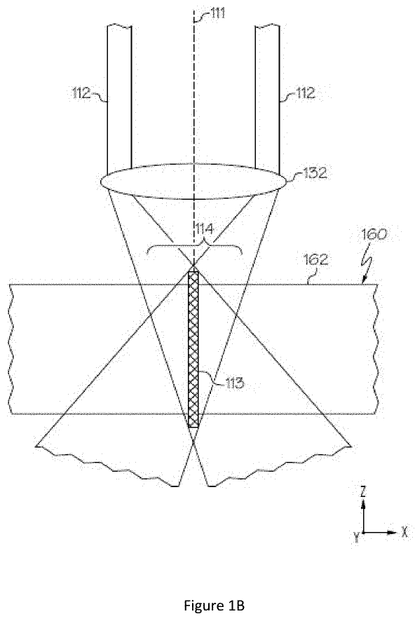

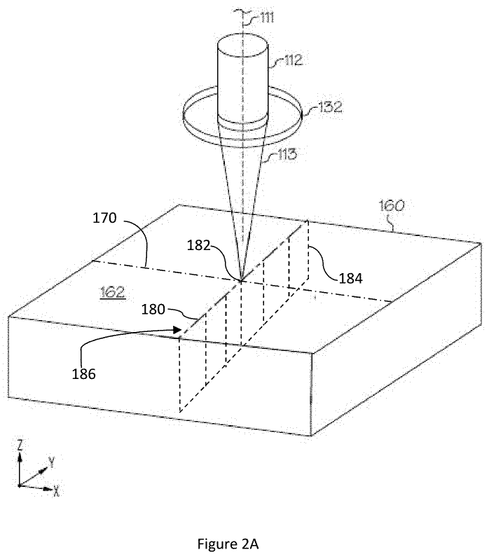

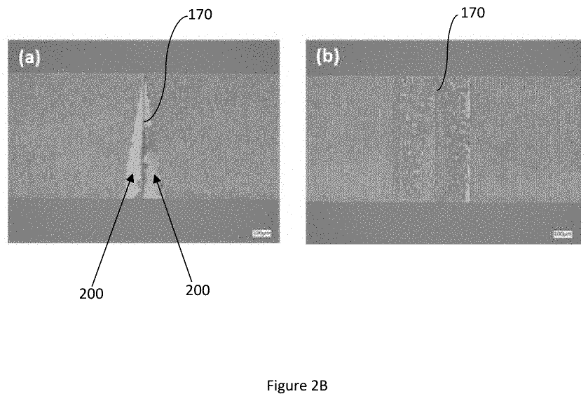

Referring now to FIGS. 1A, 1B, and 2A, 2B by way of example, a transparent workpiece 160, such as a glass workpiece or a glass-ceramic workpiece, is schematically depicted undergoing processing according to the methods described herein. FIGS. 1A and 1B depict the formation of a first contour line 170 in the transparent workpiece 160, which may be formed by translating a pulsed laser beam 112 and the transparent workpiece 160 relative to one another such that the pulsed laser beam 112 translates relative to the transparent workpiece 160 in a translation direction 101. FIG. 2A depicts the formation of a second contour line 180 in the transparent workpiece 160, which may be formed by translating the pulsed laser beam 112 and the transparent workpiece 160 relative to one another such that the pulsed laser beam 112 translates relative to the transparent workpiece 160 in a translation direction where the second contour line 180 intersects the first contour line 170 at an intersection point 182. In embodiments, the pulsed laser beam 112 translates relative to the transparent workpiece 160 in a translation direction where the second contour line 180 orthogonally intersects the first contour line 170 at an intersection point 182.

During formation of the second contour line 180, the laser pulse energy of the pulsed laser beam 112 is increased from a first laser pulse energy to a second laser pulse energy at a first distance from the intersection point in order to account for absorbtion of at least some of the laser power from the pulsed laser beam 112 which occurs proximate the position of the first contour line 170. As a result of the absorption increase of at least some of the laser power from the pulsed laser beam with decreasing distance to the first contour line 170, the second contour line 180 is altered in the region proximate the first contour line 170 and therefore would not form a complete defect within the transparent material but because of an increase of laser pulse energy the second contour line 180 may form a complete defect within the transparent material. The first distance is the distance at which the optical area (i.e the area of induced absorption within the transparent workpiece) of the pulsed laser beam interacts with an optical area of the first contour line 170 resulting in absorbtion of at least some of the laser power from the pulsed laser beam 112. This distance is dependent on the laser parameters, composition of the transparent material, and the thickness of the transparent material. For example, without limiting the embodiments described herein, for a transparent material having a thickness of 0.7 mm the laser pulse energy is increased about 100 μm to about 500 μm before reaching the intersection point of the first contour line 170. In embodiments, for a transparent material having a thickness of 0.7 mm, the laser pulse energy is increased about 100 μm to about 400 μm, or in embodiments about 100 μm to about 300 μm, or in embodiments about 100 μm to about 200 μm, about 100 μm to about 150 μm before reaching the intersection point of the first contour line 170

FIG. 2B depicts two cross sections of a transparent material. The cross-section on the left labelled “(a)” depicts a transparent material having perforations formed without increasing the laser pulse energy at a first distance from the intersection point. The cross-section (a) of FIG. 2B depicts a “shadow area” 200 proximate the first contour line 170 where absorbtion of at least some of the laser power from the pulsed laser beam 112 proximate the position of the first contour line 170 prevents formation of complete defects within the transparent material. A “complete defect” is a defect that begins at a first point on a surface of or within the transparent material and extends past the shadow area by increasing the laser pulse energy of the pulsed laser beam 112 from a first laser pulse energy to a second laser pulse energy. In embodiments, a complete defect is a defect that that extends completely through the entire thickness of the transparent material. In embodiments, the complete defect extends past the shadow area but does not extend through the entire thickness of the transparent material. The cross-section on the right of FIG. 2B, labelled “(b)”, depicts a transparent material having perforations formed with increasing the laser pulse energy proximate the first contour line 170. As shown in the cross-section (b) of FIG. 2B, increasing the laser pulse energy resulted in the formation of complete defects within the transparent material. Further details of the formation of the first contour line 170 and the second contour line 180 are described below.

In embodiments, a “shadow area” may also occur proximate the edges of the transparent workpiece where absorbtion of at least some of the laser power from the pulsed laser beam 112 proximate the edges prevents formation of complete defects within the transparent material. Accordingly, the laser pulse energy of the pulsed laser beam is increased from a first laser pulse energy to a second laser pulse energy at a first distance to an edge of the transparent material where an optical area of the pulsed laser beam interacts with an optical area of the edge of the transparent material. In embodiments, for a transparent material having a thickness of 0.7 mm, the laser pulse energy is increased about 100 μm to about 400 μm, or in embodiments about 100 μm to about 300 μm, or in embodiments about 100 μm to about 200 μm, about 100 μm to about 150 μm before reaching the edge of the transparent workpiece. In embodiments, the laser pulse energy is decreased from the second laser pulse energy to the first laser pulse energy at a second distance away from the edge where the optical area of the pulsed laser beam does not interact with the optical area of the edge of the transparent workpiece.

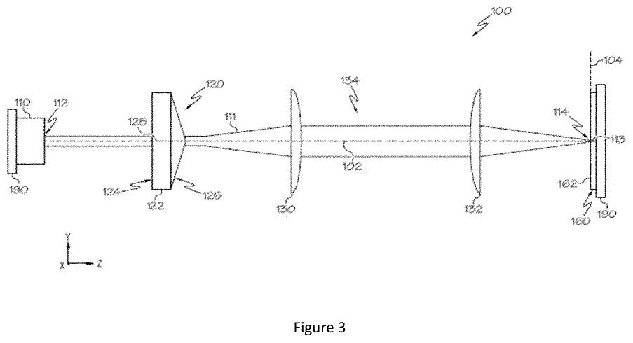

FIGS. 1A, 1B and 2A depict the pulsed laser beam 112 along a beam pathway 111 and oriented such that the pulsed laser beam 112 may be focused into a pulsed laser beam focal line 113 within the transparent workpiece 160 using an aspheric optical element 120 (FIG. 3), for example, an axicon and one or more lenses (e.g., a first lens 130 and a second lens 132, as described below and depicted in FIG. 3). Further, the pulsed laser beam focal line 113 is a portion of a quasi non-diffracting beam, as defined in more detail below.

FIGS. 1A,1B, and 2A depict that the pulsed laser beam 112 forms a laser beam focal line 113 oriented to the beam propagation direction and comprised of multiple beam spots. A beam spot 114 of the laser beam focal line 113 is projected onto an imaging surface 162 of the transparent workpiece 160. As used herein the “imaging surface” 162 of the transparent workpiece 160 is the surface of the transparent workpiece 160 at which the pulsed laser beam 112 initially contacts the transparent workpiece 160. As also used herein “beam spot” refers to a cross section of a laser beam (e.g., the pulsed laser beam 112) at a focal point at or within a workpiece (e.g., the transparent workpiece 160). In embodiments, the pulsed laser beam focal line 113 may comprise an axisymmetric cross section in a direction normal the beam pathway 111 (e.g., an axisymmetric beam spot) and in other embodiments, the pulsed laser beam focal line 113 may comprise a non-axisymmetric cross section in a direction normal the beam pathway 111 (e.g., a non-axisymmetric beam spot). As used herein, axisymmetric refers to a shape that is symmetric, or appears the same, for any arbitrary rotation angle made about a central axis, and “non-axisymmetric” refers to a shape that is not symmetric for any arbitrary rotation angle made about a central axis. A circular beam spot is an example of an axisymmetric beam spot and an elliptical beam spot is an example of a non-axisymmetric beam spot. The rotation axis (e.g., the central axis) is most often taken as being the propagation axis of the laser beam (e.g., the beam pathway 111). Example pulsed laser beams comprising a non-axisymmetric beam cross section are described in more detail in U.S. Provisional Pat. App. No. 62/402,337, titled “Apparatus and Methods for Laser Processing Transparent Workpieces Using Non-Axisymmetric Beam Spots,” herein incorporated by reference in its entirety.

The contour lines 170, 180 extend along a contour 165, 186 which delineates a line of intended separation in the transparent workpiece 160. The first contour line 170 comprises a plurality of defects 172 that extend into the surface of the transparent workpiece 160 and establish a path for separation of material of the transparent workpiece 160 from the remaining transparent workpiece 160, for example, by applying a chemical etching solution to the transparent workpiece 160. Similarly, the second contour line 180 comprises a plurality of defects 184 that extend into the surface of the transparent workpiece 160 and establish a path for separation of material of the transparent workpiece 160 from the remaining transparent workpiece 160

Referring to FIGS. 1A, 1B, and 2A, in the embodiments described herein, a pulsed laser beam 112 (with a beam spot 114) projected onto the transparent workpiece 160 may be directed onto the transparent workpiece 160 (e.g., condensed into a high aspect ratio line focus that penetrates through at least a portion of the thickness of the transparent workpiece 160). This forms the pulsed laser beam focal line 113. In one embodiment the laser beam focal line 113 is orientated such that the first beam spot 114 of the pulsed laser beam focal line 113 is within the transparent workpiece 160 (i.e. below the top surface of the transparent workpiece 160 and between the top surface and the bottom surface of the transparent workpiece 160). The pulsed laser beam focal line 113 penetrates at least a portion of the transparent workpiece 160.

Further, the pulsed laser beam 112 may be translated relative to the transparent workpiece 160 (e.g., in the translation direction 101) to form the plurality of defects 172, 184 of each contour line 170, 180. Directing or localizing the pulsed laser beam 112 into the transparent workpiece 160 generates an induced absorption within the transparent workpiece 160 and deposits enough energy to break chemical bonds in the transparent workpiece 160 at spaced locations to form the defects 172, 184. According to one or more embodiments, the pulsed laser beam 112 may be translated across the transparent workpiece 160 by motion of the transparent workpiece 160 (e.g., motion of a translation stage coupled to the transparent workpiece 160), motion of the pulsed laser beam 112 (e.g., motion of the pulsed laser beam focal line 113), or motion of both the transparent workpiece 160 and the pulsed laser beam focal line 113. By translating the pulsed laser beam focal line 113 relative to the transparent workpiece 160, the plurality of defects 172, 184 may be formed in the transparent workpiece 160.

Referring again to FIGS. 1A, 1B, and 2A, the pulsed laser beam 112 used to form the defects 172 further has an intensity distribution I(X,Y,Z), where Z is the beam propagation direction of the pulsed laser beam 112, and X and Y are directions orthogonal to the direction of propagation, as depicted in the figures. The X-direction and Y-direction may also be referred to as cross-sectional directions and the X-Y plane may be referred to as a cross-sectional plane. The intensity distribution of the pulsed laser beam 112 in a cross-sectional plane may be referred to as a cross-sectional intensity distribution.

The pulsed laser beam 112 may comprise a quasi-non-diffracting beam, for example, a beam having low beam divergence as mathematically defined below, by propagating the pulsed laser beam 112 (e.g., outputting the pulsed laser beam 112, such as a Gaussian beam, using a beam source 110) through an aspheric optical element 120, as described in more detail below with respect to the optical assembly 100 depicted in FIG. 3. Beam divergence refers to the rate of enlargement of the beam cross section in the direction of beam propagation (i.e., the Z direction). As used herein, the phrase “beam cross section” refers to the cross section of the pulsed laser beam 112 along a plane perpendicular to the beam propagation direction of the pulsed laser beam 112, for example, along the X-Y plane. Example quasi non-diffracting beams include Gauss-Bessel beams and Bessel beams.

Diffraction is one factor that leads to divergence of pulsed laser beams 112. Other factors include focusing or defocusing caused by the optical systems forming the pulsed laser beams 112 or refraction and scattering at interfaces. Pulsed laser beams 112 for forming the defects 172 of the contour line 170 may have beam spots 114 with low divergence and weak diffraction. The divergence of the pulsed laser beam 112 is characterized by the Rayleigh range Z_{R}, which is related to the variance σ² of the intensity distribution and beam propagation factor M² of the pulsed laser beam 112. In the discussion that follows, formulas will be presented using a Cartesian coordinate system. Corresponding expressions for other coordinate systems are obtainable using mathematical techniques known to those of skill in the art. Additional information on beam divergence can be found in the articles entitled “New Developments in Laser Resonators” by A. E. Siegman in SPIE Symposium Series Vol. 1224, p. 2 (1990) and “M² factor of Bessel-Gauss beams” by R. Borghi and M. Santarsiero in Optics Letters, Vol. 22(5), 262 (1997), the disclosures of which are incorporated herein by reference in their entirety. Additional information can also be found in the international standards ISO 11146-1:2005(E) entitled “Lasers and laser-related equipment—Test methods for laser beam widths, divergence angles and beam propagation ratios—Part 1: Stigmatic and simple astigmatic beams”, ISO 11146-2:2005(E) entitled “Lasers and laser-related equipment—Test methods for laser beam widths, divergence angles and beam propagation ratios—Part 2: General astigmatic beams”, and ISO 11146-3:2004(E) entitled “Lasers and laser-related equipment—Test methods for laser beam widths, divergence angles and beam propagation ratios—Part 3: Intrinsic and geometrical laser beam classification, propagation and details of test methods”, the disclosures of which are incorporated herein by reference in their entirety.

The spatial coordinates of the centroid of the intensity profile of the pulsed laser beam 112 having a time-averaged intensity profile I(x,y,z) are given by the following expressions:

$$\begin{matrix}\overline{x} ( z ) = \frac{{\int }_{- ∞}^{∞} {\int }_{- ∞}^{∞} xI ( x , y , z ) d x d y}{{\int }_{- ∞}^{∞} {\int }_{- ∞}^{∞} I ( x , y , z ) d x d y} & ( 1 ) \\ \overline{y} ( z ) = \frac{{\int }_{- ∞}^{∞} {\int }_{- ∞}^{∞} yI ( x , y , z ) d x d y}{{\int }_{- ∞}^{∞} {\int }_{- ∞}^{∞} I ( x , y , z ) d x d y} & ( 2 )\end{matrix}$$

These are also known as the first moments of the Wigner distribution and are described in Section 3.5 of ISO 11146-2:2005(E). Their measurement is described in Section 7 of ISO 11146-2:2005(E).

Variance is a measure of the width, in the cross-sectional (X-Y) plane, of the intensity distribution of the pulsed laser beam 112 as a function of position z in the direction of beam propagation. For an arbitrary laser beam, variance in the X-direction may differ from variance in the Y-direction. We let σₓ² (z) and σ_{y}² (z) represent the variances in the X-direction and Y-direction, respectively. Of particular interest are the variances in the near field and far field limits. We let σ₀ₓ² (z) and σ_{0y}² (z) represent variances in the X-direction and Y-direction, respectively, in the near field limit, and we let σ_{∞x}² (z) and σ_{∞y}² (z) represent variances in the X-direction and Y-direction, respectively, in the far field limit. For a laser beam having a time-averaged intensity profile I(x,y,z) with Fourier transform Ĩ(vₓ, v_{y}) (where vₓ and v_{y} are spatial frequencies in the X-direction and Y-direction, respectively), the near field and far field variances in the X-direction and Y-direction are given by the following expressions:

$$\begin{matrix}{σ}_{0 x}^{2} ( z ) = \frac{{\int }_{- ∞}^{∞} {\int }_{- ∞}^{∞} {x}^{2} I ( x , y , z ) dxd y}{{\int }_{- ∞}^{∞} {\int }_{- ∞}^{∞} I ( x , y , z ) dxd y} & ( 3 ) \\ {σ}_{0 y}^{2} ( z ) = \frac{{\int }_{- ∞}^{∞} {\int }_{- ∞}^{∞} {y}^{2} I ( x , y , z ) d x d y}{{\int }_{- ∞}^{∞} {\int }_{- ∞}^{∞} I ( x , y , z ) d x d y} & ( 4 ) \\ {σ}_{∞ x}^{2} = \frac{{\int }_{- ∞}^{∞} {\int }_{- ∞}^{∞} {v}_{x}^{2} \tilde{I} ( {v}_{x} , {v}_{y} ) d {v}_{x} d {v}_{y}}{{\int }_{- ∞}^{∞} {\int }_{- ∞}^{∞} \tilde{I} ( {v}_{x} , {v}_{y} ) d {v}_{x} d {v}_{y}} & ( 5 ) \\ {σ}_{∞ y}^{2} = \frac{{\int }_{- ∞}^{∞} {\int }_{- ∞}^{∞} {v}_{y}^{2} \tilde{I} ( {v}_{x} , {v}_{y} ) d {v}_{x} d {v}_{y}}{{\int }_{- ∞}^{∞} {\int }_{- ∞}^{∞} \tilde{I} ( {v}_{x} , {v}_{y} ) d {v}_{x} d {v}_{y}} & ( 6 )\end{matrix}$$

The variance quantities σ₀ₓ²(z), σ_{0y}²(z), σ_{∞x}², and σ_{∞y}² are also known as the diagonal elements of the Wigner distribution (see ISO 11146-2:2005(E)). These variances can be quantified for an experimental laser beam using the measurement techniques described in Section 7 of ISO 11146-2:2005(E). In brief, the measurement uses a linear unsaturated pixelated detector to measure I(x,y) over a finite spatial region that approximates the infinite integration area of the integral equations which define the variances and the centroid coordinates. The appropriate extent of the measurement area, background subtraction and the detector pixel resolution are determined by the convergence of an iterative measurement procedure described in Section 7 of ISO 11146-2:2005(E). The numerical values of the expressions given by equations 1-6 are calculated numerically from the array of intensity values as measured by the pixelated detector.

Through the Fourier transform relationship between the transverse amplitude profile ũ(x,y,z) for an arbitrary optical beam (where I(x,y,z)≡|ũ(x,y,z)|²) and the spatial-frequency distribution \tilde{P}(vₓ, v_{y}, z) for an arbitrary optical beam (where Ĩ(vₓ, v_{y})≡|\tilde{P}(vₓ, v_{y}, z)|²), it can be shown that:

σₓ²(z)=σ₀ₓ²(z₀ₓ)+λ²σ_{∞x}²(z−z₀ₓ)² (7)

σ_{y}²(z)=σ_{0y}²(z_{0y})+λ²σ_{∞y}²(z−z_{0y})² (8)

In equations (7) and (8), σ₀ₓ²(z₀ₓ) and σ_{0y}²(z_{0y}) are minimum values of σ₀ₓ²(z) and σ_{0y}²(z), which occur at waist positions z₀ₓ and z_{0y} in the x-direction and y-direction, respectively, and λ is the wavelength of the pulsed laser beam 112. Equations (7) and (8) indicate that σₓ² (z) and σ_{y}²(z) increase quadratically with z in either direction from the minimum values associated with the waist position of the pulsed laser beam 112 (e.g., the waist portion of the pulsed laser beam focal line 113). Further, in the embodiments described herein comprising a beam spot 114 that is axisymmetric and thereby comprises an axisymmetric intensity distribution I(x,y), σₓ²(z)=σ_{y}²(z) and in the embodiments described herein comprising a beam spot 114 that is non-axisymmetric and thereby comprises a non-axisymmetric intensity distribution I(x,y), σₓ²(z)≠σ_{y}²(z), i.e., σₓ²(z)<σ_{y}²(z) or σₓ²(z)>σ_{y}²(z).

Equations (7) and (8) can be rewritten in terms of a beam propagation factor M², where separate beam propagations factors Mₓ² and M_{y}² for the x-direction and the y-direction are defined as:

Mₓ²≡4πσ₀ₓσ_{∞x} (9)

M_{y}²≡4πσ_{0y}σ_{∞y} (10)

Rearrangement of Equations (9) and (10) and substitution into Equations (7) and (8) yields:

$$\begin{matrix}{σ}_{x}^{2} ( z ) = {σ}_{0 x}^{2} ( {z}_{0 x} ) + \frac{{λ}^{2} {M}_{x}^{4}}{{( 4 π {σ}_{0 x} )}^{2}} {( z - {z}_{0 x} )}^{2} & ( 11 ) \\ {σ}_{y}^{2} ( z ) = {σ}_{0 y}^{2} ( {z}_{0 y} ) + \frac{{λ}^{2} {M}_{y}^{4}}{{( 4 π {σ}_{0 y} )}^{2}} {( z - {z}_{0 y} )}^{2} & ( 12 )\end{matrix}$$

which can be rewritten as:

$$\begin{matrix}{σ}_{x}^{2} ( z ) = {σ}_{0 x}^{2} ( {z}_{0 x} ) [ 1 + \frac{{( z - {z}_{0 x} )}^{2}}{{Z}_{R x}^{2}} ] & ( 13 ) \\ {σ}_{y}^{2} ( z ) = {σ}_{0 y}^{2} ( {z}_{0 y} ) [ 1 + \frac{{( z - {z}_{0 y} )}^{2}}{{Z}_{R y}^{2}} ] & ( 14 )\end{matrix}$$

where the Rayleigh ranges Z_{Rx} and Z_{Ry} in the x-direction and y-direction, respectively, are given by:

$$\begin{matrix}{Z}_{R x} = \frac{4 π {σ}_{0 x}^{2}}{{M}_{x}^{2} λ} & ( 15 ) \\ {Z}_{R y} = \frac{4 π {σ}_{0 y}^{2}}{{M}_{y}^{2} λ} & ( 16 )\end{matrix}$$

The Rayleigh range corresponds to the distance (relative to the position of the beam waist as defined in Section 3.12 of ISO 11146-1:2005(E)) over which the variance of the laser beam doubles (relative to the variance at the position of the beam waist) and is a measure of the divergence of the cross sectional area of the laser beam. Further, in the embodiments described herein comprising a beam spot 114 that is axisymmetric and thereby comprises an axisymmetric intensity distribution I(x,y), Z_{Rx}=Z_{Ry} and in the embodiments described herein comprising a beam spot 114 that is non-axisymmetric and thereby comprises a non-axisymmetric intensity distribution I(x,y), Z_{Rx}≠Z_{Ry}, i.e., Z_{Rx}<Z_{Ry} or Z_{Rx}>Z_{Ry}. The Rayleigh range can also be observed as the distance along the beam axis at which the optical intensity decays to one half of its value observed at the beam waist location (location of maximum intensity). Laser beams with large Rayleigh ranges have low divergence and expand more slowly with distance in the beam propagation direction than laser beams with small Rayleigh ranges.

The formulas above can be applied to any laser beam (not just Gaussian beams) by using the intensity profile I(x,y,z) that describes the laser beam. In the case of the TEM₀₀ mode of a Gaussian beam, the intensity profile is given by:

$$I ( x , y ) = \frac{\sqrt{π}}{2} {w}_{o} {e}^{\frac{- 2 ( {x}^{2} + {y}^{2} )}{{w}_{o}^{2}}} \qquad ( 17 )$$

where wₒ is the radius (defined as the radius at which beam intensity decreases to 1/e² of the peak beam intensity of the beam at a beam waist position zₒ. From Equation (17) and the above formulas, we obtain the following results for a TEM₀₀ Gaussian beam:

$$\begin{matrix}{σ}_{0 x}^{2} = {σ}_{0 y}^{2} = \frac{{w}_{o}^{2}}{4} & ( 18 ) \\ {σ}_{∞ x}^{2} = {σ}_{∞ y}^{2} = \frac{1}{4 {π}^{2} {w}_{o}^{2}} & ( 19 ) \\ {M}_{x}^{2} = 4 π {σ}_{0 x} {σ}_{∞ x} = 1 & ( 20 ) \\ {M}_{y}^{2} = 4 π {σ}_{0 y} {σ}_{∞ y} = 1 & ( 21 ) \\ {Z}_{R x} = \frac{4 π {σ}_{0 x}^{2}}{{M}_{x}^{2} λ} = \frac{π {w}_{0}^{2}}{λ} & ( 22 ) \\ {Z}_{R y} = \frac{4 π {σ}_{0 y}^{2}}{{M}_{y}^{2} λ} = \frac{π {w}_{0}^{2}}{λ} & ( 23 ) \\ {w}^{2} ( z ) = {w}_{0}^{2} + \frac{{λ}^{2}}{{( π {w}_{0} )}^{2}} {( z - {z}_{0} )}^{2} = {w}_{0}^{2} [ 1 + \frac{{( z - {z}_{0} )}^{2}}{{Z}_{R}^{2}} ] & ( 24 )\end{matrix}$$

where Z_{R}=Z_{Rx}=Z_{Ry}. For Gaussian beams, it is further noted that M²=Mₓ²=M_{y}²=1.

Beam cross section is characterized by shape and dimensions. The dimensions of the beam cross section are characterized by a spot size of the beam. For a Gaussian beam, spot size is frequently defined as the radial extent at which the intensity of the beam decreases to 1/e² of its maximum value, denoted in Equation (17) as w₀. The maximum intensity of a Gaussian beam occurs at the center (x=0 and y=0 (Cartesian) or r=0 (cylindrical)) of the intensity distribution and radial extent used to determine spot size is measured relative to the center.

Beams with axisymmetric (i.e. rotationally symmetric around the beam propagation axis Z) cross sections can be characterized by a single dimension or spot size that is measured at the beam waist location as specified in Section 3.12 of ISO 11146-1:2005(E). For a Gaussian beam, Equation (17) shows that spot size is equal to wₒ, which from Equation (18) corresponds to 2σ₀ₓ or 2σ_{0y}. For an axisymmetric beam having an axisymmetric cross section, such as a circular cross section, σ₀ₓ=σ_{0y}. Thus, for axisymmetric beams, the cross section dimension may be characterized with a single spot size parameter, where wₒ=2σ₀. Spot size can be similarly defined for non-axisymmetric beam cross sections where, unlike an axisymmetric beam, σ₀ₓ≠σ_{0y}. Thus, when the spot size of the beam is non-axisymmetric, it is necessary to characterize the cross-sectional dimensions of a non-axisymmetric beam with two spot size parameters: w₀ₓ and w_{0y} in the x-direction and y-direction, respectively, where

w₀ₓ=2σ₀ₓ (25)

w_{0y}=2σ_{0y} (25)

Further, the lack of axial (i.e. arbitrary rotation angle) symmetry for a non-axisymmetric beam means that the results of a calculation of values of σ₀ₓ and σ_{0y} will depend on the choice of orientation of the X-axis and Y-axis. ISO 11146-1:2005(E) refers to these reference axes as the principal axes of the power density distribution (Section 3.3-3.5) and in the following discussion we will assume that the X and Y axes are aligned with these principal axes. Further, an angle ϕ about which the X-axis and Y-axis may be rotated in the cross-sectional plane (e.g., an angle of the X-axis and Y-axis relative to reference positions for the X-axis and Y-axis, respectively) may be used to define minimum (w_{o,min}) and maximum values (w_{o,max}) of the spot size parameters for a non-axisymmetric beam:

w_{o,min}=2σ_{0,min} (27)

w_{o,max}=2σ_{0,max} (28)

where 2σ_{0,min}=2σ₀ₓ(ϕ_{min,x})=2σ_{0y}(ϕ_{min,y}) and 2σ_{0,max}=2σ₀ₓ (ϕ_{max,x})=2σ_{0y}(ϕ_{max,y}) The magnitude of the axial asymmetry of the beam cross section can be quantified by the aspect ratio, where the aspect ratio is defined as the ratio of w_{o,max} to w_{o,min}. An axisymmetric beam cross section has an aspect ratio of 1.0, while elliptical and other non-axisymmetric beam cross sections have aspect ratios greater than 1.0, for example, greater than 1.1, greater than 1.2, greater than 1.3, greater than 1.4, greater than 1.5, greater than 1.6, greater than 1.7, greater than 1.8, greater than 1.9, greater than 2.0, greater than 3.0, greater than 5.0, greater than 10.0, or the like

To promote uniformity of defects 172, 184 in the beam propagation direction (e.g. depth dimension of the transparent workpiece 160), a pulsed laser beam 112 having low divergence may be used. In one or more embodiments, pulsed laser beams 112 having low divergence may be utilized for forming defects 172, 184. As noted above, divergence can be characterized by the Rayleigh range. For non-axisymmetric beams, Rayleigh ranges for the principal axes X and Y are defined by Equations (15) and (16) for the X-direction and Y-direction, respectively, where it can be shown that for any real beam, Mₓ²>1 and M_{y}²>1 and where σ₀ₓ² and σ_{0y}² are determined by the intensity distribution of the laser beam. For symmetric beams, Rayleigh range is the same in the X-direction and Y-direction and is expressed by Equation (22) or Equation (23). Low divergence correlates with large values of the Rayleigh range and weak diffraction of the laser beam.

Beams with Gaussian intensity profiles may be less preferred for laser processing to form defects 172, 184 because, when focused to small enough spot sizes (such as spot sizes in the range of microns, such as about 1-5 μm or about 1-10 μm) to enable available laser pulse energies to modify materials such as glass, they are highly diffracting and diverge significantly over short propagation distances. To achieve low divergence, it is desirable to control or optimize the intensity distribution of the pulsed laser beam to reduce diffraction. Pulsed laser beams may be non-diffracting or weakly diffracting. Weakly diffracting laser beams include quasi-non-diffracting laser beams. Representative weakly diffracting laser beams include Bessel beams, Gauss-Bessel beams, Airy beams, Weber beams, and Mathieu beams.

For non-axisymmetric beams, the Rayleigh ranges Z_{Rx} and Z_{Ry} are unequal. Equations (15) and (16) indicate that Z_{Rx} and Z_{Ry} depend on σ₀ₓ and σ_{0y}, respectively, and above we noted that the values of σ₀ₓ and σ_{0y} depend on the orientation of the X-axis and Y-axis. The values of Z_{Rx} and Z_{Ry} will accordingly vary, and each will have a minimum value and a maximum value that correspond to the principal axes, with the minimum value of Z_{Rx} being denoted as Z_{Rx,min} and the minimum value of Z_{Ry} being denoted Z_{Ry,min} for an arbitrary beam profile Z_{Rx,min} and Z_{Ry,min} can be shown to be given by

$$\begin{matrix}{Z}_{Rx , min} = \frac{4 π {σ}_{0 , min}^{2}}{{M}_{x}^{2} λ} & ( 29 ) \\ and & \\ {Z}_{Ry , min} = \frac{4 π {σ}_{0 , min}^{2}}{{M}_{y}^{2} λ} & ( 30 )\end{matrix}$$

Since divergence of the laser beam occurs over a shorter distance in the direction having the smallest Rayleigh range, the intensity distribution of the pulsed laser beam 112 used to form defects 172 may be controlled so that the minimum values of Z_{Rx} and Z_{Ry} (or for axisymmetric beams, the value of Z_{R}) are as large as possible. Since the minimum value Z_{Rx,min} of Z_{Rx} and the minimum value Z_{Ry,min} of Z_{Ry} differ for a non-axisymmetric beam, a pulsed laser beam 112 may be used with an intensity distribution that makes the smaller of Z_{Rx,min} and Z_{Ry,min} as large as possible when forming damage regions.

In different embodiments, the smaller of Z_{Rx,min} and Z_{Ry,min} (or for axisymmetric beams, the value of Z_{R}) is greater than or equal to 50 μm, greater than or equal to 100 μm, greater than or equal to 200 μm, greater than or equal to 300 μm, greater than or equal to 500 μm, greater than or equal to 1 mm, greater than or equal to 2 mm, greater than or equal to 3 mm, greater than or equal to 5 mm, in the range from 50 μm to 10 mm, in the range from 100 μm to 5 mm, in the range from 200 μm to 4 mm, in the range from 300 μm to 2 mm, or the like.

The values and ranges for the smaller of Z_{Rx,min} and Z_{Ry,min} (or for axisymmetric beams, the value of Z_{R}) specified herein are achievable for different wavelengths to which the workpiece is transparent through adjustment of the spot size parameter w_{o,min} defined in Equation (27). In different embodiments, the spot size parameter w_{o,min} is greater than or equal to 0.25 μm, greater than or equal to 0.50 μm, greater than or equal to 0.75 μm, greater than or equal to 1.0 μm, greater than or equal to 2.0 μm, greater than or equal to 3.0 μm, greater than or equal to 5.0 μm, in the range from 0.25 μm to 10 μm, in the range from 0.25 μm to 5.0 μm, in the range from 0.25 μm to 2.5 μm, in the range from 0.50 μm to 10 μm, in the range from 0.50 μm to 5.0 μm, in the range from 0.50 μm to 2.5 μm, in the range from 0.75 μm to 10 μm, in the range from 0.75 μm to 5.0 μm, in the range from 0.75 μm to 2.5 μm, or the like.

Non-diffracting or quasi non-diffracting beams generally have complicated intensity profiles, such as those that decrease non-monotonically vs. radius. By analogy to a Gaussian beam, an effective spot size w_{o,eff} can be defined for non-axisymmetric beams as the shortest radial distance, in any direction, from the radial position of the maximum intensity (r=0) at which the intensity decreases to 1/e² of the maximum intensity. Further, for axisymmetric beams w_{o,eff} is the radial distance from the radial position of the maximum intensity (r=0) at which the intensity decreases to 1/e² of the maximum intensity. A criterion for Rayleigh range based on the effective spot size w_{o,eff} for non-axisymmetric beams or the spot size wₒ for axisymmetric beams can be specified as non-diffracting or quasi non-diffracting beams for forming damage regions using equation (31) for non-axisymmetric beams of equation (32) for axisymmetric beams, below:

$$\begin{matrix}Smaller of {Z}_{Rx , min} , {Z}_{Ry , min} > {F}_{D} \frac{π {w}_{0 , eff}^{2}}{λ} & ( 31 ) \\ {Z}_{R} > {F}_{D} \frac{π {w}_{0}^{2}}{λ} & ( 32 )\end{matrix}$$

where F_{D} is a dimensionless divergence factor having a value of at least 10, at least 50, at least 100, at least 250, at least 500, at least 1000, in the range from 10 to 2000, in the range from 50 to 1500, in the range from 100 to 1000. By comparing Equation (31) to Equation (22) or (23), one can see that for a non-diffracting or quasi non-diffracting beam the distance, Smaller of Z_{Rx,min},Z_{Ry,min} in Equation (31), over which the effective beam size doubles, is F_{D} times the distance expected if a typical Gaussian beam profile were used. The dimensionless divergence factor F_{D} provides a criterion for determining whether or not a laser beam is quasi-non-diffracting. As used herein, the pulsed laser beam 112 is considered quasi-non-diffracting if the characteristics of the laser beam satisfy Equation (31) or Equation (32) with a value of F_{D}≥10. As the value of F_{D} increases, the pulsed laser beam 112 approaches a more nearly perfectly non-diffracting state. Moreover, it should be understood that Equation (32) is merely a simplification of Equation (31) and as such, Equation (31) mathematically describes the dimensionless divergence factor F_{D} for both axisymmetric and non-axisymmetric pulsed laser beams 112.

Referring now to FIG. 3, an optical assembly 100 for producing a pulsed laser beam 112 that is quasi-non-diffracting and forms the pulsed laser beam focal line 113 at the transparent workpiece 160 using the aspheric optical element 120 (e.g., an axicon 122) is schematically depicted. The optical assembly 100 includes a beam source 110 that outputs the pulsed laser beam 112, and a first and second lens 130, 132.

Further, the transparent workpiece 160 may be positioned such that the pulsed laser beam 112 output by the beam source 110 irradiates the transparent workpiece 160, for example, after traversing the aspheric optical element 120 and thereafter, both the first lens 130 and the second lens 132. An optical axis 102 extends between the beam source 110 and the transparent workpiece 160 along the Z-axis such that when the beam source 110 outputs the pulsed laser beam 112, the beam pathway 111 of the pulsed laser beam 112 extends along the optical axis 102. As used herein “upstream” and “downstream” refer to the relative position of two locations or components along the beam pathway 111 with respect to the beam source 110. For example, a first component is upstream from a second component if the pulsed laser beam 112 traverses the first component before traversing the second component. Further, a first component is downstream from a second component if the pulsed laser beam 112 traverses the second component before traversing the first component.

Referring still to FIG. 3, the beam source 110 may comprise any known or yet to be developed beam source 110 configured to output pulsed laser beams 112. In operation, the defects 172, 184 of the respective contour line 170, 180 (FIGS. 1A and 2A) are produced by interaction of the transparent workpiece 160 with the pulsed laser beam 112 output by the beam source 110. In embodiments, the beam source 110 may output a pulsed laser beam 112 comprising a wavelength of for example, 1064 nm, 1030 nm, 532 nm, 530 nm, 355 nm, 343 nm, or 266 nm, or 215 nm. Further, the pulsed laser beam 112 used to form defects 172, 184 in the transparent workpiece 160 may be well suited for materials that are transparent to the selected pulsed laser wavelength.

Suitable laser wavelengths for forming defects 172, 184 are wavelengths at which the combined losses of linear absorption and scattering by the transparent workpiece 160 are sufficiently low. In embodiments, the combined losses due to linear absorption and scattering by the transparent workpiece 160 at the wavelength are less than 20%/mm, or less than 15%/mm, or less than 10%/mm, or less than 5%/mm, or less than 1%/mm, where the dimension “/mm” means per millimeter of distance within the transparent workpiece 160 in the beam propagation direction of the pulsed laser beam 112 (e.g., the Z direction). Representative wavelengths for many glass workpieces include fundamental and harmonic wavelengths of Nd³⁺ (e.g. Nd³⁺:YAG or Nd³⁺:YVO₄ having fundamental wavelength near 1064 nm and higher order harmonic wavelengths near 532 nm, 355 nm, and 266 nm). Other wavelengths in the ultraviolet, visible, and infrared portions of the spectrum that satisfy the combined linear absorption and scattering loss requirement for a given substrate material can also be used.

In operation, the pulsed laser beam 112 output by the beam source 110 may create multi-photon absorption (MPA) in the transparent workpiece 160. MPA is the simultaneous absorption of two or more photons of identical or different frequencies that excites a molecule from one state (usually the ground state) to a higher energy electronic state (i.e., ionization). The energy difference between the involved lower and upper states of the molecule is equal to the sum of the energies of the involved photons. MPA, also called induced absorption, can be a second-order or third-order process (or higher order), for example, that is several orders of magnitude weaker than linear absorption. It differs from linear absorption in that the strength of second-order induced absorption may be proportional to the square of the light intensity, for example, and thus it is a nonlinear optical process.

The perforation step that creates the contour line 170, 180 (FIGS. 1A and 2A) may utilize the beam source 110 (e.g., an ultra-short pulse laser) in combination with the aspheric optical element 120, the first lens 130, and the second lens 132, to project the beam spot 114 on the transparent workpiece 160 and generate the pulsed laser beam focal line 113. The pulsed laser beam focal line 113 comprises a quasi non-diffracting beam, such as a Gauss-Bessel beam or Bessel beam, as defined above, and may fully perforate the transparent workpiece 160 to form defects 172, 184 in the transparent workpiece 160, which may form the respective contour line 170, 180. In embodiments, the pulse duration of the individual pulses is in a range of from about 1 femtosecond to about 200 picoseconds, such as from about 1 picosecond to about 100 picoseconds, 5 picoseconds to about 20 picoseconds, or the like, and the repetition rate of the individual pulses may be in a range from about 1 kHz to 4 MHz, such as in a range from about 10 kHz to about 3 MHz, or from about 10 kHz to about 650 kHz.

Referring again to FIG. 3, the aspheric optical element 120 is positioned within the beam pathway 111 between the beam source 110 and the transparent workpiece 160. In operation, propagating the pulsed laser beam 112, e.g., an incoming Gaussian beam, through the aspheric optical element 120 may alter the pulsed laser beam 112 such that the portion of the pulsed laser beam 112 propagating beyond the aspheric optical element 120 is quasi-non-diffracting, as described above. The aspheric optical element 120 may comprise any optical element comprising an aspherical shape. In embodiments, the aspheric optical element 120 may comprise a conical wavefront producing optical element, such as an axicon lens, for example, a negative refractive axicon lens, a positive refractive axicon lens, a reflective axicon lens, a diffractive axicon lens, a programmable spatial light modulator axicon lens (e.g., a phase axicon), or the like.

In embodiments, the aspheric optical element 120 comprises at least one aspheric surface whose shape is mathematically described as: z′=(cr²/1)₊ (1−(1+k)(c²r²))^{1/2}+(a₁r+a₂r²+a₃r³+a₄r⁴+a₅r⁵+a₆r⁶+a₇r⁷+a₈r⁸+a₉r⁹+a₁₀r¹⁰+a₁₁r¹¹+a₁₂r¹² where z′ is the surface sag of the aspheric surface, r is the distance between the aspheric surface and the optical axis 102 in a radial direction (e.g., in an X-direction or a Y-direction), c is the surface curvature of the aspheric surface (i.e. cᵢ=1/Rᵢ, where R is the surface radius of the aspheric surface), k is the conic constant, and coefficients a₁ are the first through the twelfth order aspheric coefficients or higher order aspheric coefficients (polynomial aspheres) describing the aspheric surface. In one example embodiment, at least one aspheric surface of the aspheric optical element 120 includes the following coefficients a₁-a₇, respectively: −0.085274788; 0.065748845; 0.077574995; −0.054148636; 0.022077021; −0.0054987472; 0.0006682955; and the aspheric coefficients a₈-a₁₂ are 0. In this embodiment, the at least one aspheric surface has the conic constant k=0. However, because the a₁ coefficient has a nonzero value, this is equivalent to having a conic constant k with a non-zero value. Accordingly, an equivalent surface may be described by specifying a conic constant k that is non zero, a coefficient a₁ that is non-zero, or a combination of a nonzero k and a non-zero coefficient a₁. Further, in embodiments, the at least one aspheric surface is described or defined by at least one higher order aspheric coefficients a₂-a₁₂ with non-zero value (i.e., at least one of a₂, a₃ . . . , a₁₂≠0). In one example embodiment, the aspheric optical element 120 comprises a third-order aspheric optical element such as a cubically shaped optical element, which comprises a coefficient a₃ that is non-zero.

In embodiments, when the aspheric optical element 120 comprises an axicon 122 (as depicted in FIG. 3), the axicon 122 may have a laser output surface 126 (e.g., conical surface) having an angle of about 1.2°, such as from about 0.5° to about 5°, or from about 1° to about 1.5°, or even from about 0.5° to about 20°, the angle measured relative to the laser input surface 124 (e.g., flat surface) upon which the pulsed laser beam 112 enters the axicon 122. Further, the laser output surface 126 terminates at a conical tip. Moreover, the aspheric optical element 120 includes a centerline axis 125 extending from the laser input surface 124 to the laser output surface 126 and terminating at the conical tip. In other embodiments, the aspheric optical element 120 may comprise an axicon, a spatial phase modulator such as a spatial light modulator, or a diffractive optical grating. In operation, the aspheric optical element 120 shapes the incoming pulsed laser beam 112 (e.g., an incoming Gaussian beam) into a quasi-non-diffracting beam, which, in turn, is directed through the first lens 130 and the second lens 132.

Referring still to FIG. 3, the first lens 130 is positioned upstream the second lens 132 and may collimate the pulsed laser beam 112 within a collimation space 134 between the first lens 130 and the second lens 132. Further, the second lens 132 may focus the pulsed laser beam 112 into the transparent workpiece 160, which may be positioned at an imaging plane 104. In embodiments, the first lens 130 and the second lens 132 each comprise plano-convex lenses. When the first lens 130 and the second lens 132 each comprise plano-convex lenses, the curvature of the first lens 130 and the second lens 132 may each be oriented toward the collimation space 134. In other embodiments, the first lens 130 may comprise other collimating lenses and the second lens 132 may comprise a meniscus lens, an asphere, or another higher-order corrected focusing lens.

Referring again to FIGS. 1A-3, a pulsed laser beam 112 is directed oriented along the beam pathway 111 and output by the beam source 110 into the transparent workpiece 160 such that the portion of the pulsed laser beam 112 directed into the transparent workpiece 160 generates an induced absorption within the transparent workpiece and the induced absorption produces defects 172, 184 within the transparent workpiece 160. For example, the pulsed laser beam 112 may comprise a pulse energy and a pulse duration sufficient to exceed a damage threshold of the transparent workpiece 160. In embodiments, directing the pulsed laser beam 112 into the transparent workpiece 160 comprises focusing the pulsed laser beam 112 output by the beam source 110 into the pulsed laser beam focal line 113 oriented along the beam propagation direction (e.g., the Z axis). The transparent workpiece 160 is positioned in the beam pathway 111 to at least partially overlap the pulsed laser beam focal line 113 of pulsed laser beam 112. The pulsed laser beam focal line 113 is thus directed into the transparent workpiece 160. The pulsed laser beam 112, e.g., the pulsed laser beam focal line 113 generates induced absorption within the transparent workpiece 160 to create the defects 172, 184 in the transparent workpiece 160. In embodiments, individual defects may be created at rates of several hundred kilohertz (i.e., several hundred thousand defects per second).

In embodiments, the aspheric optical element 120 may focus the pulsed laser beam 112 into the pulsed laser beam focal line 113. In operation, the position of the pulsed laser beam focal line 113 may be controlled by suitably positioning and/or aligning the pulsed laser beam 112 relative to the transparent workpiece 160 as well as by suitably selecting the parameters of the optical assembly 100. For example, the position of the pulsed laser beam focal line 113 may be controlled along the Z-axis and about the Z-axis. Further, the pulsed laser beam focal line 113 may have a length in a range of from about 0.1 mm to about 100 mm or in a range of from about 0.1 mm to about 10 mm. Various embodiments may be configured to have a pulsed laser beam focal line 113 with a length 1 of about 0.1 mm, about 0.2 mm, about 0.3 mm, about 0.4 mm, about 0.5 mm, about 0.7 mm, about 1 mm, about 2 mm, about 3 mm, about 4 mm, or about 5 mm e.g., from about 0.5 mm to about 5 mm.

Referring still to FIGS. 1A-2A, the method for forming the contour lines 170, 180 comprising defects 172, 184 may include translating the transparent workpiece 160 relative to the pulsed laser beam 112 (or the pulsed laser beam 112 may be translated relative to the transparent workpiece 160, for example, in the translation direction 101 depicted in FIGS. 1A and 2A). The defects 172, 184 penetrate the full depth of the glass. It should be understood that while sometimes described as “holes” or “hole-like,” the defects 172 disclosed herein may generally not be void spaces, but are rather portions of the transparent workpiece 160 which has been modified by laser processing as described herein.

In embodiments, the defects 172, 184 may generally be spaced apart from one another by a distance along the contour line 170, 180 of from about 0.1 μm to about 500 μm, for example, about 1 μm to about 200 μm, about 2 μm to about 100 μm, about 5 μm to about 20 μm, or the like. For example, suitable spacing between the defects may be from about 0.1 μm to about 50 μm, such as from about 5 μm to about 15 μm, from about 5 μm to about 12 μm, from about 7 μm to about 15 μm, or from about 7 μm to about 12 μm for the TFT/display glass compositions. In embodiments, a spacing between adjacent defects may be about 50 μm or less, 45 μm or less, 40 μm or less, 35 μm or less, 30 μm or less, 25 μm or less, 20 μm or less, 15 μm or less, 10 μm or less, 5 μm or less or the like. Further, the translation of the transparent workpiece 160 relative to the pulsed laser beam 112 may be performed by moving the transparent workpiece 160 and/or the beam source 110 using one or more translation stages 190.

Beyond the perforation of a single transparent workpiece 160, the process may also be used to perforate stacks of transparent workpieces 160, such as stacks of sheets of glass, and may fully perforate glass stacks of up to a few mm total height with a single laser pass. A single glass stack may be comprised of various glass types within the stack, for example one or more layers of soda-lime glass layered with one or more layers of Corning code 2318 glass. The glass stacks additionally may have air gaps in various locations. According to another embodiment, ductile layers such as adhesives may be disposed between the glass stacks. However, the pulsed laser process described herein will still, in a single pass, fully perforate both the upper and lower glass layers of such a stack.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method for processing a transparent workpiece, the method comprising:
forming a first contour line in the transparent workpiece, the first contour line comprising a first plurality of defects in the transparent workpiece such that the first contour line defines a first contour, wherein forming the first contour line comprises:
directing a first pulsed laser beam oriented along a beam pathway and output by a beam source through an aspheric optical element and into the transparent workpiece such that a portion of the first pulsed laser beam directed into the transparent workpiece generates an induced absorption within the transparent workpiece, the induced absorption creating a defect within the transparent workpiece; and
translating the transparent workpiece and the first pulsed laser beam relative to each other along the first contour line, thereby laser forming the first plurality of defects along the first contour line within the transparent workpiece;
forming a second contour line in the transparent workpiece, the second contour line comprising a second plurality of defects in the transparent workpiece such that the second contour line defines a second contour intersecting the first contour line at an intersection point, wherein forming the second contour line comprises:
directing a second pulsed laser beam oriented along a beam pathway and output by a beam source through an aspheric optical element and into the transparent workpiece such that a portion of the second pulsed laser beam directed into the transparent workpiece generates an induced absorption within the transparent workpiece, the induced absorption producing a modification of the transparent workpiece along the second contour line to create a defect within the transparent workpiece; and
translating the transparent workpiece and the second pulsed laser beam relative to each other along the second contour line, thereby laser forming the second plurality of defects along the contour line within the transparent workpiece,
wherein the laser pulse energy of the second pulsed laser beam is increased from a first laser pulse energy to a second laser pulse energy at a first distance from the intersection point where an optical area of the second pulsed laser beam interacts with an optical area of the first contour line; and
wherein the laser pulse energy of the second pulsed laser beam is decreasing from the second laser pulse energy to the first laser pulse energy at a second distance from the intersection point where the optical area of the second pulsed laser beam does not interact with the optical area of the first contour line.

2. The method of claim 1, wherein the portion of the first pulsed laser beam directed into the transparent workpiece comprises:
a wavelength λ;
a spot size wₒ; and
a cross section that comprises a Rayleigh range Z_{R} that is greater than
$${F}_{D} \frac{π {w}_{0 ,}^{2}}{λ} ,$$
where F_{D} is a dimensionless divergence factor comprising a value of 10 or greater.

3. The method of claim 1, wherein the portion of the second pulsed laser beam directed into the transparent workpiece comprises:
a wavelength λ;
a spot size wₒ; and
a cross section that comprises a Rayleigh range Z_{R} that is greater than
$${F}_{D} \frac{π {w}_{0 ,}^{2}}{λ} ,$$
where F_{D} is a dimensionless divergence factor comprising a value of 10 or greater

4. The method of claim 1, wherein the second laser pulse energy is twice the first laser pulse energy.

5. The method of claim 1, wherein the first distance is about 100 μm to about 500 μm.

6. The method of claim 1, wherein the first distance is about 100 μm to about 300 μm.

7. The method of claim 1, wherein the second distance is about 100 μm to about 500 μm.

8. The method of claim 1, wherein the second distance is about 100 μm to about 300 μm.

9. The method of claim 1, wherein the first pulsed laser beam and second pulsed laser beam has a wavelength λ and wherein the transparent workpiece has combined losses due to linear absorption and scattering less than 20%/mm in the beam propagation direction.

10. The method of claim 1, wherein the first beam source and second beam source comprises respectively a first pulsed beam source and a second pulsed beam source that produces pulse bursts with from about 2 sub-pulses per pulse burst to about 30 sub-pulses per pulse burst and a pulse burst energy is from about 100 μJ to about 600 μJ per pulse burst.

11. A transparent workpiece, comprising:
a first contour line in the transparent workpiece, wherein the first contour line comprises a first plurality of defects in the transparent workpiece; and
a second contour line in the transparent workpiece, the second contour line comprising a second plurality of defects in the transparent workpiece such that the second contour line defines a second contour intersecting the first contour line at an intersection point, wherein the second plurality of defects extends at least partially through a thickness of the transparent workpiece from a first distance prior to the intersection point to a second distance after the intersection point.

12. The transparent workpiece of claim 11, wherein the second plurality of defects extends completely through the thickness of the transparent workpiece at the intersection point.

13. The transparent workpiece of claim 11, wherein the first distance is about 100 μm to about 500 μm.

14. The transparent workpiece of claim 11, wherein the first distance is about 100 μm to about 300 μm.

15. The transparent workpiece of claim 11, wherein the second distance is about 100 μm to about 500 μm.

16. A method for processing a transparent workpiece, the method comprising:
forming a first contour line in the transparent workpiece, the first contour line comprising a first plurality of defects in the transparent workpiece such that the first contour line defines a first contour, wherein forming the first contour line comprises:
directing a first pulsed laser beam oriented along a beam pathway and output by a beam source through an aspheric optical element and into the transparent workpiece such that a portion of the first pulsed laser beam directed into the transparent workpiece generates an induced absorption within the transparent workpiece, the induced absorption producing a modification of the transparent workpiece along the first contour line to create a defect within the transparent workpiece; and
translating the transparent workpiece and the first pulsed laser beam relative to each other along the first contour line, thereby laser forming the first plurality of defects along the first contour line within the transparent workpiece;
wherein the laser pulse energy of the first pulsed laser beam is increased from the first laser pulse energy to the second laser pulse energy at a first distance to an edge of the transparent material where an optical area of the first pulsed laser beam interacts with an optical area of the edge of the transparent material.

17. The method of claim 16, wherein the portion of the first pulsed laser beam directed into the transparent workpiece comprises:
a wavelength λ;
a spot size wₒ; and
a cross section that comprises a Rayleigh range Z_{R} that is greater than
$${F}_{D} \frac{π {w}_{0 ,}^{2}}{λ} ,$$
where F_{D} is a dimensionless divergence factor comprising a value of 10 or greater.

18. The method of claim 16, where in the second laser pulse energy is twice the first laser pulse energy.

19. The method of claim 16, wherein the first pulsed laser beam and second pulsed laser beam has a wavelength λ and wherein the transparent workpiece has combined losses due to linear absorption and scattering less than 20%/mm in the beam propagation direction.

20. The method of claim 16, wherein the first beam source and second beam source comprises respectively a first pulsed beam source and a second pulsed beam source that produces pulse bursts with from about 2 sub-pulses per pulse burst to about 30 sub-pulses per pulse burst and a pulse burst energy is from about 100 μJ to about 600 μJ per pulse burst.
